(19) United States
(12) Patent Application Publication
(10) Pub. No.: US 2026/0104950 A1
(43) Pub. Date: Apr. 16, 2026

(54) TECHNIQUES FOR EXECUTING APPLICATION CODE ACROSS MULTIPLE CONTAINERS IN A SERVERLESS COMPUTING ENVIRONMENT

(71) Applicant: NETFLIX, INC., Los Gatos, CA (US)

(72) Inventors: Poorna Chandra Tejashvi REDDY, Fremont, CA (US); Ameya VASANI, Los Gatos, CA (US); Rosanna LEE, Palo Alto, CA (US); Olof JOHANSSON, Los Gatos, CA (US); David WADDEN, Falls Church, VA (US); David JULIA, Denver, CO (US)

(21) Appl. No.: 18/916,612

(22) Filed: Oct. 15, 2024

(51) Int. Cl. G06F 9/54; G06F 9/50

(52) U.S. Cl. CPC G06F 9/546; G06F 9/5022; G06F 9/544

(57) ABSTRACT

In various embodiments, a computer-implemented method for executing application code across different execution environments includes causing a first function container to execute a first function based on a first portion of the application code to generate first output data, and causing a second function container to execute a second function based on a second portion of the application code to generate second output data, where the first function executes within a first execution environment associated with the first container, and wherein the second function executes within a second execution environment associated with the second container.

### BACKGROUND

### Field of the Various Embodiments

The various embodiments relate generally to computer science and cloud computing and, more specifically, to techniques for executing application code across multiple containers in a serverless computing environment.

### Description of the Related Art

In a serverless computing model, an application developer writes application code that is executed within a container or other type of managed execution environment. The container typically runs on cloud infrastructure, including virtual and/or physical machines, that is not directly configurable by the application developer. The serverless computing model has gained widespread adoption because application developers can focus on writing business logic without needing to set up or maintain the underlying cloud infrastructure.

Generally speaking, a container is composed of a base layer and one or more additional layers. The base layer references a base image that is derived from a given operating system (OS). Each additional layer describes operations that further configure the base image, including, and without limitation, creating files and directories, installing additional software, and setting environment variables. The application developer writes the application code using one or more programming languages that are installed in the container via the base image or the one or more additional layers. In a conventional serverless computing model, application code normally executes within the execution environment of a single container.

One drawback of the single-container model is that, during container development, a given container is configured to include tools, libraries, and other programming resources that are compatible with the OS of the base image from which the container is derived. The container typically cannot be configured to include other programming resources that are not compatible with the OS of that base image. Consequently, application code is usually developed to only leverage programming resources available on one specific type of container derived from one OS. This technical restriction significantly narrows the scope of programming resources that the application developer can access when developing application code for a specific container.

Another drawback of the single-container model described above is that in many cloud environments, the application developer can only access tools, libraries, and other programming resources that are already defined within the base image or the additional layers of the container, and cannot easily add new programming resources. In some instances, the various layers of the container can be updated to include programming resources not previously installed in the container. However, in large organizations that rely on stable and well-understood versions of containers, making changes to widely used container configurations is usually infeasible.

Yet another drawback of the single-container model is that a container designed to run on certain cloud platforms generally has to be rebuilt when one or more underlying platform dependencies change, even when the container, application code, and/or application code dependencies are unchanged. In some instances, the application code contains hundreds of individual functions and/or dependencies. Rebuilding all of these functions and/or dependencies usually requires the repetition of a rigorous and lengthy testing cycle, thereby lengthening application development time. In certain instances, individual layers of containers can be managed and tested separately, but this approach is a non-standard practice that oftentimes is not sustainable.

An additional drawback of the single-container model is that the application developer typically has to calculate the specific processing and memory resources that are required by the container to execute the application code and then has to configure the container with those specific resources. However, in many instances the container already executes business logic with a resource footprint that is unknown to the application developer. Consequently, accurate resource calculations oftentimes cannot be made, potentially leading to technically infeasible container configurations. Furthermore, implementing this level of container configuration in practice is misaligned with the general philosophy of the serverless computing model because the application developer is forced to shift focus away from developing business logic and instead focus on determining container resource and configuration requirements.

As the foregoing illustrates, what is needed in the art are more effective techniques for executing application code in a serverless computing environment.

### SUMMARY

In various embodiments, a computer-implemented method for executing application code across different execution environments includes causing a first function container to execute a first function based on a first portion of the application code to generate first output data, and causing a second function container to execute a second function based on a second portion of the application code to generate second output data, where the first function executes within a first execution environment associated with the first container, and wherein the second function executes within a second execution environment associated with the second container.

At least one technical advantage of the disclosed techniques relative to the prior art is that the disclosed techniques enable application code to leverage tools, libraries, and other programming resources that are compatible with different OSs via different function containers. Therefore, application code is not limited to using only tools, libraries, and other programming resources that are compatible with a single OS, significantly expanding the scope of resources that are available to application developers when developing application code. Further, application code developers need not implement custom interface logic between application code and function containers. Another technical advantage of the disclosed techniques is that additional function containers can be deployed to provide access to additional tools, libraries, and other programming resources without needing to make changes to stable and well-understood versions of containers. Yet another technical advantage of the disclosed techniques is that each function container can be updated independently of the other function containers. Accordingly, updates to a given function container generally impact only the function code developed for the execution environment of that container, thereby expediting the application development process. An additional technical advantage of the disclosed techniques is that processing and memory resources can be pre-allocated for each function container relative to the function code that executes on that container without allocating resources needed for the platform runtime. This approach simplifies the configuration process because processing and memory resources need not be calculated at the application code level, and application developers can therefore focus on the development of business logic rather than container resource and configuration requirements. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 illustrates an exemplary configuration of computing environments generated by the container manager of FIG. 1, according to various embodiments;

FIG. 3 illustrates how the agent container and function containers of FIGS. 1-2 coordinate function execution, according to various embodiments;

FIG. 4 sets forth a flow diagram of methods steps for executing application code across different function containers, according to various embodiments

FIG. 5 depicts one architecture of a system within which embodiments of the present disclosure may be implemented.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

In a serverless computing model, an application developer writes application code that is executed within a container or other type of managed execution environment. A container is composed of a base layer and one or more additional layers. The base layer references a base image that is derived from a given operating system (OS). Each additional layer describes operations that further configure the base image. In a conventional serverless computing model, application code normally executes within the execution environment of a single container.

One drawback of the single-container model is that, during container development, a given container can only be configured to include tools, libraries, and other programming resources that are compatible with the OS of the base image from which the container is derived. This technical restriction narrows the scope of programming resources the application developer can leverage when developing application code for a specific container to only those resources that are compatible with the OS of that specific container. Another drawback of the single-container model described above is that the application developer can only access tools, libraries, and other programming resources that are defined within the base image or the additional layers of the container. To leverage programming resources not currently installed in the container, the various layers of the container have to be updated, which is oftentimes infeasible. Yet another drawback of the single-container model is that required updates to a container configuration, including security patches and bug fixes, generally mandate that all application code developed for the container be rebuilt. Rebuilding all application code can require the repetition of a rigorous and lengthy testing cycle, thereby lengthening application development time. An additional drawback of the single-container model is that the application developer typically has to calculate the specific processing and memory resources that are required by the container to execute the application code and then has to configure the container with those specific resources. However, accurate resource calculations oftentimes cannot be made, potentially leading to technically infeasible container configurations.

To address the above issues, an agent container and one or more function containers are deployed within a serverless computing environment. The agent container coordinates the execution of application code across the one or more function containers. Each function container can be configured to provide a different execution environment for performing processing tasks set forth in various portions of the application code. The agent container and the function containers are coupled to shared storage that provides a communication mechanism between the different containers. The agent container is configured to poll a task queue for messages corresponding to various processing tasks. Based on a given message, the agent container configures the shared storage to handle output data associated with a corresponding processing task. The agent container then causes a function container to execute function code that performs the processing task and generates output data. The agent container is configured to perform the process described above in conjunction with multiple different containers that execute function code associated with different execution environments.

At least one technical advantage of the disclosed techniques relative to the prior art is that the disclosed techniques enable application code to leverage tools, libraries, and other programming resources that are compatible with different OSs via different function containers. Another technical advantage of the disclosed techniques is that additional function containers can be deployed to provide access to additional tools, libraries, and other programming resources without needing to make changes to stable and well-understood versions of containers. Yet another technical advantage of the disclosed techniques is that each function container can be updated independently of the other function containers. An additional technical advantage of the disclosed techniques is that processing and memory resources can be pre-allocated for each function container relative to the function code that executes on that container without allocating resources needed for the platform runtime. These technical advantages provide one or more technological advancements over prior art approaches.

### System Overview

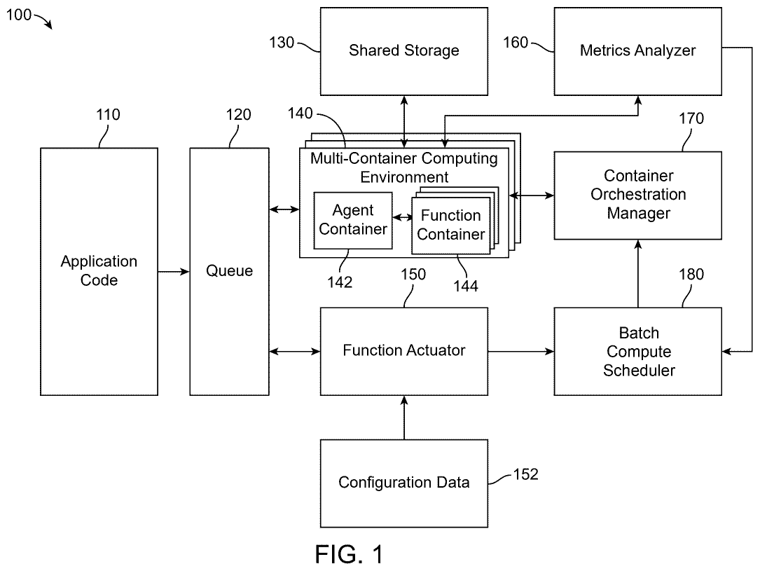

FIG. 1 is a conceptual illustration of a system configured to implement one or more aspects of the various embodiments. As shown, a system 100 includes application code 110, queue 120, shared storage 130, multi-container computing environment 140, function activator 150, configuration data 152, metrics analyzer 160, container orchestration manager 170, and batch compute manager 180. System 100 and the various components shown generally represent a cloud-based computing environment that can be implemented via any technically feasible combination of physical and/or virtual machines. Persons skilled in the art will understand that some or all of system 100 can be implemented using serverless cloud technologies.

Application code 110 may be any technically feasible software application written in any technically feasible programming language or combination of programming languages. In one embodiment, application code 110 may be a media processing application configured to perform a sequence of media processing operations. Application code 110 generally indicates a set of processing tasks to be performed within multi-container computing environment 140. When executed by a processor, application code 110 causes those tasks to be performed.

As is shown, multi-container computing environment 140 includes an agent container 142 and one or more function containers 144. In various embodiments, multi-container computing environment 140 may further include at least a portion of shared storage 130, where that portion is coupled to both agent container 142 and function container(s) 144. A given function container 144 is configured to execute one or more functions corresponding to a given processing task set forth in application code 110. Agent container 142 coordinates the execution of different functions across the different function containers 144 to perform the various processing tasks described in application code 110. Each function container 144 can be configured according to a different OS, a different base image, and/or a different set of layers. Each function container 144 can also be updated independently of other function containers 144. A given function container 144 is generally pre-configured with appropriate processor and memory resources needed for function execution. Accordingly, multi-container computing environment 140 exposes a powerful mechanism through which developers of application code 110 can efficiently leverage a wide range of tools, libraries, and other programming resources without excessive configuration.

In operation, application code 110 coordinates the execution of processing tasks by populating queue 120 with messages that describe various processing tasks. In one embodiment, application code 110 may include a workflow and/or an application programming interface (API). The workflow may include a directed acyclic graph (DAG), state machine, or other form of process orchestration that, when triggered, pushes one or more messages onto queue 120. The API may expose a set of endpoints that can be triggered via remote procedure calls (RPCs) to push one or more messages onto queue 120.

Function actuator 150 is configured to monitor queue 120 to measure expected workload. In so doing, function actuator 150 may analyze configuration data 152 to identify specific resources that are needed by each function to be executed. Function actuator 150 conveys workload metrics to batch compute manager 180. Batch compute manager 180 coordinates batch processing across a set of physical and/or virtual machines and schedules compute operations according to a fair and capacity-aware scheduling policy. In one embodiment, batch compute manager 180 may include one or more load balancers. Batch compute manager 180 coordinates scheduling with container orchestration manager 170.

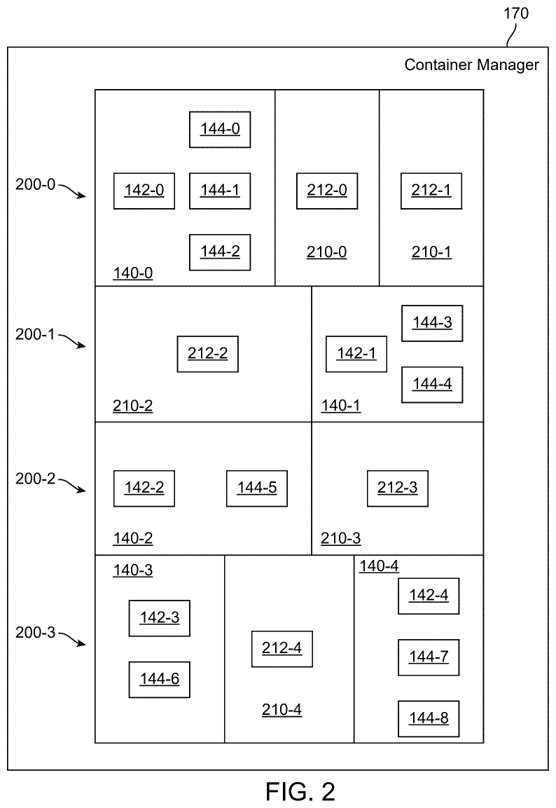

Container orchestration manager 170 is a cloud-based entity configured to manage and run containers at scale. Container orchestration manager 170 is generally responsible for launching containers within an underlying compute environment. In one embodiment, container orchestration manager 170 may include functionality derived from Kubernetes technology. Container orchestration manager 170 launches containers within multi-container computing environments 140 and/or single-container computing environments (not shown here). Container orchestration manager 170 can launch many such execution environments in parallel with one another, as is described in greater detail below in conjunction with FIG. 2.

Agent container 142 and function container(s) 144 within multi-container computing environment 140 are coupled to shared storage 130. Shared storage 130 provides a communication mechanism between containers within multi-container computing environments 140, thereby allowing those containers to share input and/or output data. Shared storage 130 may include any technically feasible storage utility and/or combination thereof, including, for example and without limitation, a Kubernetes shared volume, persistent storage, object-based storage, database storage, or microservice layers deployed across underlying storage, among others.

Metrics analyzer 160 includes observation functionality for measuring the performance of the various computing environments created and/or managed by container orchestration manager 170, as well as the underlying infrastructure on which those containers execute, including physical and/or virtual machines. Metrics analyzer 160 communicates execution metrics to batch compute manager 180 to inform scheduling, scaling, and/or load balancing operations.

FIG. 2 illustrates an exemplary configuration of computing environments generated by the container manager of FIG. 1, according to various embodiments. As shown, container orchestration manager 170 includes a set of computing slots 200. Each computing slot 200 can include any number of multi-container computing environments 140 and/or any number of single-container computing environments 210. Container orchestration manager 170 configures containers within any given computing slot 200 with access to shared storage 130 and/or a specific portion of shared storage 130 corresponding to that computing slot 200.

In the example shown, computing slot 200-0 includes multi-container computing environment 140-0, single-container computing environment 210-0, and single-container computing environment 210-0. Multi-container computing environment 140-0 includes agent container 142-0 and function containers 144-0, 144-1, and 144-2. Single-container computing environment 210-0 includes container 212-0, and single-container computing environment 210-1 includes container 212-1. Computing slot 200-1 includes single-container computing environment 210-2 and multi-container computing environment 140-1. Single-container computing environment 210-2 includes container 212-2, and multi-container computing environment 140-1 includes agent container 142-1 and function containers 144-3 and 144-4. Computing slot 200-2 includes multi-container computing environment 140-2 and single-container computing environment 210-3. Multi-container computing environment 140-2 includes agent container 142-2 and function container 144-5, and single-container computing environment 210-3 includes container 212-3. Computing slot 200-3 includes multi-container computing environment 140-3, single-container computing environment 210-4, and multi container computing environment 140-4. Multi-container computing environment 140-3 includes agent container 142-3 and function container 144-6. Single-container computing environment 210-4 includes container 212-4. Multi-container computing environment 140-4 includes agent container 142-4 and function containers 144-7 and 144-8. Persons skilled in the art will understand that the exemplary configuration shown is not meant to limit the scope of the present embodiments.

In one embodiment, container orchestration manager 170 implements at least a portion of the functionality of a Kubernetes cluster, and each computing slot 200 includes a set of Kubernetes pods. In this embodiment, each of multi-container computing environment 140-0 and single-container computing environment 210-0 may be implemented via a different Kubernetes pod.

Container orchestration manager 170 is configured to generate configurations of environments similar to the example shown in order to perform a wide range of processing tasks, including, for example and without limitation, media processing tasks, audiovisual encoding and/or decoding, and so forth. Some such tasks can be performed using the execution environment provided by a single container. Those processing tasks can be performed via a single-container computing environment 210. Other processing tasks may need multiple different execution environments provided by different containers to leverage multiple different tools, libraries, and/or programming resources with different OS compatibilities. These processing tasks, on the other hand, can be performed via one or more multi-container computing environments 140.

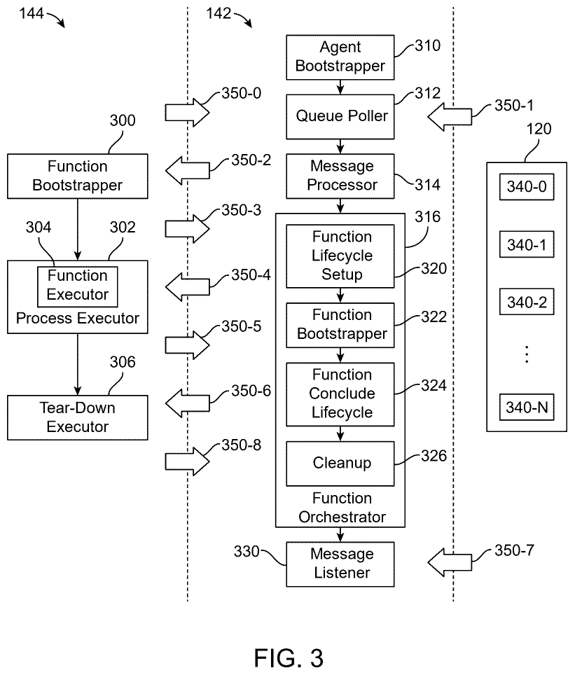

As a general matter, a given multi-container computing environment includes an agent container 142 and any technically feasible number of function containers 144. The agent container 142 coordinates the operation of the different function containers 144. Each function container 144 can implement a different execution environment that can be derived from any technically feasible OS. A given function container 144 is configured to implement at least one specific function that is configured to execute within the execution environment of that function container. The agent container 142 is configured to obtain processing tasks to be performed by function containers 144 by accessing messages stored in queue 120. The agent container 142 then coordinates the execution of different functions, across different function containers 144, to handle the processing tasks set forth in those messages. The lifecycle and communication mechanisms of agent containers 142 and function containers 144 is described in greater detail below in conjunction with FIG. 3.

FIG. 3 illustrates how the agent container and function containers of FIGS. 1-2 coordinate function execution, according to various embodiments. As shown, function container 144 includes function bootstrapper 300, process executor 302, and tear-down executor 306. Process executor 302 includes function executor 304. As also shown, agent container 142 includes agent bootstrapper 310, queue poller 312, message processor 314, function orchestrator 316, and message listener 330. Function orchestrator 316 includes function lifecycle setup 320, function bootstrapper 322, function conclude lifecycle 324, and cleanup 326. Queue 120 includes messages 340-0 through 340-N.

Function container 144, agent container 142, and queue 120 are configured transmit and receive various events 350 to coordinate operation with one another. Events 350 can be transmitted and received through a variety of different communication mechanisms, including, for example and without limitation, a publish/subscribe (pub/sub) channel, an inter-process communication (IPC) channel, a message queue, and so forth. In various embodiments, events may be transmitted via communication mechanisms made available via shared storage 130.

In operation, container orchestration manager 170 shown in FIGS. 1-2 launches agent container 142 and one or more function containers 144 to perform processing tasks corresponding to messages 340 in queue 120. During launch, function bootstrapper 300 creates a pub/sub mechanism to communicate with agent container 142 and agent bootstrapper 310 likewise creates a pub/sub mechanism to communicate with function container 144. When ready, function bootstrapper 300 transmits event 350-0 indicating that function container 144 is ready to receive processing tasks. Agent bootstrapper 310 receives event 350-0 and, in response, causes queue poller 312 to poll queue 120. Queue poller 312 receives event 350-1 from queue 120 that includes message data derived from an event 340. In various embodiments, queue poller 312 may receive events 340 directly, depending on the technical implementation of queue 120. Message processor 314 processes message data received via event 350-1 and then initiates the operation of function orchestrator 316.

Function lifecycle setup 320 within function orchestrator 316 prepares various resources for function execution, including, for example and without limitation, creating one or more working directories in shared storage 130, transforming function arguments, creating additional communication channels, and/or creating a command channel. Function bootstrapper 322 then issues a command to function bootstrapper 300 via event 350-2 to initiate function execution. Function bootstrapper 300, in response, initializes process executor 302 based on the received command line arguments and then issues event 350-3 to function orchestrator 316 indicating that bootstrapping is complete. Function orchestrator 316 then issues event 350-4 indicating that function execution should commence.

Process executor 302 then calls function executor 304. Function executor 304 executes function code along with the command line arguments received from function orchestrator 316 within the execution environment provided by function container 144. Function executor 304 generates output data returned via execution of the function code and publishes output data to function orchestrator 316 via event 350-5. Function conclude lifecycle 324 then uploads output data to shared storage 130 and transmits event 350-6 to function container 142. Event 350-6 indicates that tear-down executor 306 should commence deallocation of resources used during function execution. When tear-down executor 306 completes the tear-down procedure, tear-down executor 306 issues event 350-8 indicating that function container 144 is ready to handle additional processing tasks.

Cleanup 326 performs a similar deallocation procedure by removing working directories from shared storage 130, as needed, and removing any contexts used by agent container 142 to coordinate the operation of function container 144. Message listener 330 waits for event 350-7, indicating that the message 340 initially pulled from queue 120 has been successfully serviced and removed from queue 120. Upon receipt of event 350-7, message listener 330 determines that the processing task associated with that message is complete, and then notifies agent bootstrapper 310 that additional processing tasks can be performed.

Agent container 142 is configured to perform the above-described process in conjunction with many different function containers 144 within a given multi-container computing environment 140, thereby providing access to many different execution environments. Accordingly, application code 110 can leverage tools, libraries, and other processing resources corresponding to any technically feasible set of containers or configuration thereof. Importantly, these techniques provide a significant shift away from conventional techniques where the execution of a conventional application is limited to the execution environment of a single container.

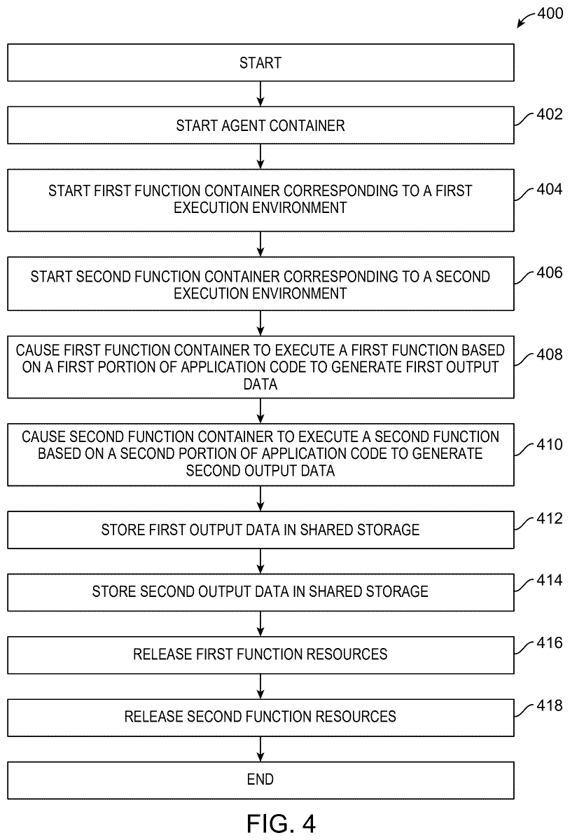

FIG. 4 sets forth a flow diagram of methods steps for executing application code across different function containers, according to various embodiments. Although the method steps are described with reference to the systems of FIGS. 1-3, persons skilled in the art will understand that any system configured to implement the method steps, in any order, falls within the scope of the embodiments.

As shown, a method 400 begins at step 402, where container orchestration manager 170 starts an agent container 142. The agent container 144 could be, for example and without limitation, agent container 142-0 shown in FIG. 2. Agent container 142 generally resides within a multi-container computing environment 140 deployed within a computing slot 200. Multi-container computing environment 140, in various embodiments, may be a Kubernetes pod. Containers within multi-container computing environment 140 can communicate with one another and/or share data via shared storage 130.

At step 404, container orchestration manager 170 starts a first function container 144 corresponding to a first execution environment. The first function container 144 could be, for example and without limitation, function container 144-0. Container orchestration manager 170 starts the first function container 144 based on signals received from batch compute manager 180 and/or function actuator 150 that reflect specific processing tasks to be performed via one or more functions supported by the first function container 144. The first execution environment generally reflects a specific distribution of an OS and/or a particular base layer and/or any number of additional layers.

At step 406, container orchestration manager 170 starts a second function container 144 corresponding to a second execution environment. The second function container 144 could be, for example and without limitation, function container 144-1 shown in FIG. 2. As with step 404, container orchestration manager 170 starts the second function container 144 based on signals received from batch compute manager 180 and/or function actuator 150 that reflect specific processing tasks to be performed via one or more functions supported by the second function container 144. Further, the second execution environment generally reflects a specific distribution of an OS and/or a particular base layer and/or any number of additional layers. The second execution environment may be derived from a different OS and/or base image than the first execution environment, and therefore may support tools, libraries, and other programming resources that are not compatible with the first execution environment, in various embodiments.

At step 408, the agent container 142 causes the first function container 144 to execute a first function based on a first portion of application code to generate first output data. As described above in conjunction with FIG. 1, when executed, application code 110 populates queue 120 with messages that reflect processing tasks to be performed via function containers 144. In performing step 408, the agent container 142 processes message data retrieved from queue 120 and performs the specific configuration steps outlined above in conjunction with FIG. 3, and then causes the first function container 144 to execute the first function. The first function executes within the first execution environment.

At step 410, the agent container 142 similarly causes the second function container 144 to execute a second function based on a second portion of application code to generate second output data. The second function executes within the second execution environment. Because the first execution environment and the second execution environment can be different, and have different compatibilities, the first function and the second function can involve the use of different libraries that are compatible with different OSs, and generally provide a potentially non-overlapping set of available features.

At step 412, agent container 142 stores the first output data in shared storage 130. In like manner, at step 414, agent container 142 stores the second output data in shared storage 130. Agent container 142 thus coordinates the behavior of the first and second function containers 144 when generating the first and second output data, respectively. Although the underlying functionality of those two function containers 144 can be different, through the coordination of agent container 142, output data can be cooperatively generated and stored in a commonly accessible location that permits future processing by other function containers 144 that may be launched within the multi-container computing environment 140.

At step 416, the first function container 144 releases various resources used during execution of the first function. At step 418, the second function container 144 releases various resources used during execution of the second function. Following steps 416 and 418, the first function container 144 and the second function container 144 can perform additional processing tasks via subsequent function executions. Further, additional function containers 144 (e.g. function container 144-2) may perform downstream processing tasks via additional function executions, potentially using output data already stored in shared storage 130.

Persons skilled in the art will understand that certain steps of the method 400 can be performed in a non-sequential manner and that each such step is not necessarily dependent on the completion of any previous step. For example, and without limitation, steps 404 and 406 can be performed in parallel and independently of one another, steps 408 and 410 can be performed in parallel and independently of one another, steps 412 and 414 can be performed in parallel and independently of one another, and steps 416 and 418 can be performed in parallel and independently of one another. As a general matter, function containers 144 within a given multi-container computing environment 140 can operate separately, although in a manner that is coordinated by agent container 142.

### System Implementation

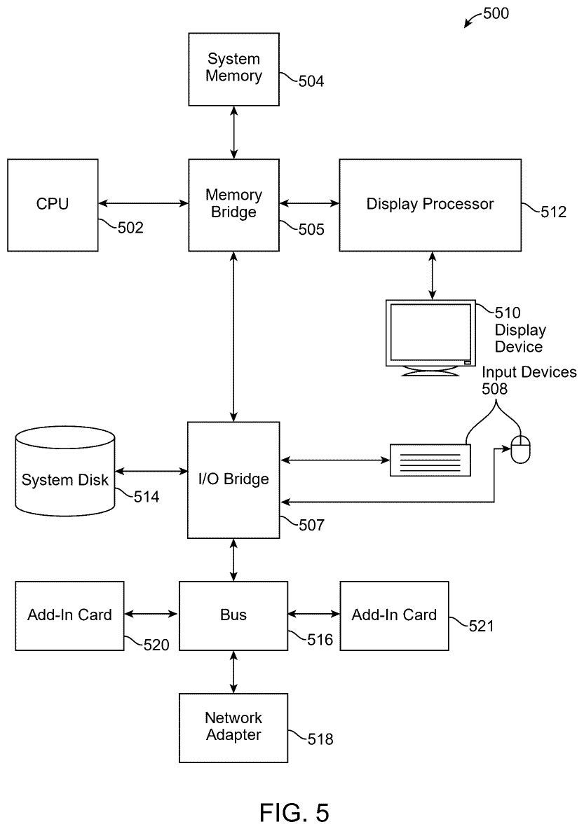

FIG. 5 depicts one architecture of a system 500 within which embodiments of the present disclosure may be implemented. This figure in no way limits or is intended to limit the scope of the present disclosure. In various implementations, system 500 may be an augmented reality, virtual reality, or mixed reality system or device, a personal computer, video game console, personal digital assistant, mobile phone, mobile device, or any other device suitable for practicing one or more embodiments of the present disclosure. Further, in various embodiments, any combination of two or more systems 500 may be coupled together to practice one or more aspects of the present disclosure.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 5110 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in Appendices A-J, attached hereto, are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments of the present disclosure, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 1. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, an agent container and one or more function containers are deployed within a serverless computing environment. The agent container coordinates the execution of application code across the one or more function containers. Each function container can be configured to provide a different execution environment for performing processing tasks set forth in various portions of the application code. The agent container and the function containers are coupled to shared storage that provides a communication mechanism between the different containers. The agent container is configured to poll a task queue for messages corresponding to various processing tasks. Based on a given message, the agent container configures the shared storage to handle output data associated with a corresponding processing task. The agent container then causes a function container to execute function code that performs the processing task and generates output data. The agent container manages the overall lifecycle of the function container, including deallocating resources used during execution of the function code. The agent container is configured to perform the process described above in conjunction with multiple different containers that execute function code associated with different execution environments.

At least one technical advantage of the disclosed techniques relative to the prior art is that the disclosed techniques enable application code to leverage tools, libraries, and other programming resources that are compatible with different OSs via different function containers. Therefore, application code is not limited to using only tools, libraries, and other programming resources that are compatible with a single OS, significantly expanding the scope of resources that are available to application developers when developing application code. Further, application code developers need not implement custom interface logic between application code and function containers. Another technical advantage of the disclosed techniques is that additional function containers can be deployed to provide access to additional tools, libraries, and other programming resources without needing to make changes to stable and well-understood versions of containers. Yet another technical advantage of the disclosed techniques is that each function container can be updated independently of the other function containers. Accordingly, updates to a given function container generally impact only the function code developed for the execution environment of that container, thereby expediting the application development process. An additional technical advantage of the disclosed techniques is that processing and memory resources can be pre-allocated for each function container relative to the function code that executes on that container without allocating resources needed for the platform runtime. This approach simplifies the configuration process because processing and memory resources need not be calculated at the application code level, and application developers can therefore focus on the development of business logic rather than container resource and configuration requirements. These technical advantages provide one or more technological advancements over prior art approaches.
1. Some embodiments include a computer-implemented method for executing application code across different execution environments, the method comprising causing a first function container to execute a first function based on a first portion of the application code to generate first output data, and causing a second function container to execute a second function based on a second portion of the application code to generate second output data, wherein the first function executes within a first execution environment associated with the first container, and wherein the second function executes within a second execution environment associated with the second container.
2. The computer-implemented method of clause 1, wherein the first container is derived from a first base image corresponding to a first operating system, and the second container is derived from a second base image corresponding to a second operating system.
3. The computer-implemented method of any of clauses 1-2, further comprising generating a multi-container computing environment that includes the first function container and the second function container, wherein the multi-container computing environment is coupled to a shared storage, and wherein the first function container and the second function container communicate with one another via the shared storage.
4. The computer-implemented method of any of clauses 1-3, further comprising executing the first portion of the application code to push a first message onto a queue, wherein the first message corresponds to a first processing task performed during execution of the first function, and executing the second portion of the application code to push a second message onto the queue, wherein the second message corresponds to a second processing task performed during execution of the second function.
5. The computer-implemented method of any of clauses 1-4, further comprising polling a queue to obtain a first message corresponding to a first processing task, configuring the first container to execute the first function based on the first message to perform the first processing task, polling the queue to obtain a second message corresponding to a second processing task, and configuring the second container to execute the second function based on the second message to perform the second processing task.
6. The computer-implemented method of any of clauses 1-5, further comprising launching an agent container within a multi-container computing environment that includes the first function container and the second function container, wherein the agent container causes the first function container to execute the first function and causes the second function container to execute the second function.
7. The computer-implemented method of any of clauses 1-6, wherein the first function comprises a first media processing operation that generates a first portion of media data, and wherein the second function comprises a second media processing operation that generates a second portion of media data.
8. The computer-implemented method of any of clauses 1-7, further comprising determining that execution of the first function is complete, causing the first function container to release one or more resources associated with the first function, determining that execution of the second function is complete, and causing the second function container to release one or more resources associated with the second function.
9. The computer-implemented method of any of clauses 1-8, further comprising determining that execution of the first function is complete, copying the first output data to a shared storage, determining that execution of the second function is complete, and copying the second output data to the shared storage, wherein the first function container and the second function container are coupled to the shared storage.
10. The computer-implemented method of any of clauses 1-9, wherein the first execution environment and the second execution environment are derived from different operating systems.
11. Some embodiments include one or more non-transitory computer-readable media including instructions that, when executed by one or more processors, cause the one or more processors to execute application code across different execution environments by performing the steps of causing a first function container to execute a first function based on a first portion of the application code to generate first output data, and causing a second function container to execute a second function based on a second portion of the application code to generate second output data, wherein the first function executes within a first execution environment associated with the first container, and wherein the second function executes within a second execution environment associated with the second container.
12. The one or more non-transitory computer-readable media of clause 11, wherein the first execution environment and the second execution environment are derived from different operating systems.
13. The one or more non-transitory computer-readable media of any of clauses 11-12, further comprising the step of generating a multi-container computing environment that includes the first function container and the second function container, wherein the multi-container computing environment is coupled to a shared storage, and wherein the first function container and the second function container communicate with one another via the shared storage.
14. The one or more non-transitory computer-readable media of any of clauses 11-13, further comprising the steps of executing the first portion of the application code to push a first message onto a queue, wherein the first message corresponds to a first processing task performed during execution of the first function, and executing the second portion of the application code to push a second message onto the queue, wherein the second message corresponds to a second processing task performed during execution of the second function.
15. The one or more non-transitory computer-readable media of any of clauses 11-14, further comprising the steps of polling a queue to obtain a first message corresponding to a first processing task, configuring the first container to execute the first function based on the first message to perform the first processing task, polling the queue to obtain a second message corresponding to a second processing task, and configuring the second container to execute the second function based on the second message to perform the second processing task.
16. The one or more non-transitory computer-readable media of any of clauses 11-15, further comprising the step of launching an agent container within a multi-container computing environment that includes the first function container and the second function container, wherein the agent container causes the first function container to execute the first function and causes the second function container to execute the second function.
17. The one or more non-transitory computer-readable media of any of clauses 11-16, wherein the first function comprises a first media processing operation that generates a first portion of media data, and wherein the second function comprises a second media processing operation that generates a second portion of media data.
18. The one or more non-transitory computer-readable media of any of clauses 11-17, wherein the first container is configured to execute a first library that is compatible with a first operating system, and the second container is configured to execute a second library that is compatible with a second operating system.
19. The one or more non-transitory computer-readable media of any of clauses 11-18, further comprising the steps of executing the first portion of the application code to trigger a rule-based workflow that populates a queue with a first message corresponding to the first function, and executing the second portion of the application code to issue an application programming interface (API) call that populates the queue with a second message corresponding to the second function.
20. Some embodiments include a system comprising one or more memories storing instructions, and one or more processors coupled to the one or more memories that, when executing the instructions, perform the steps of causing a first function container to execute a first function based on a first portion of application code to generate first output data, and causing a second function container to execute a second function based on a second portion of the application code to generate second output data, wherein the first function executes within a first execution environment associated with the first container, and wherein the second function executes within a second execution environment associated with the second container.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer. ” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more non-transitory computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for executing application code across different execution environments, the method comprising:
causing a first function container to execute a first function based on a first portion of the application code to generate first output data; and
causing a second function container to execute a second function based on a second portion of the application code to generate second output data,
wherein the first function executes within a first execution environment associated with the first container, and wherein the second function executes within a second execution environment associated with the second container.

2. The computer-implemented method of claim 1, wherein the first container is derived from a first base image corresponding to a first operating system, and the second container is derived from a second base image corresponding to a second operating system.

3. The computer-implemented method of claim 1, further comprising generating a multi-container computing environment that includes the first function container and the second function container, wherein the multi-container computing environment is coupled to a shared storage, and wherein the first function container and the second function container communicate with one another via the shared storage.

4. The computer-implemented method of claim 1, further comprising:
executing the first portion of the application code to push a first message onto a queue, wherein the first message corresponds to a first processing task performed during execution of the first function; and
executing the second portion of the application code to push a second message onto the queue, wherein the second message corresponds to a second processing task performed during execution of the second function.

5. The computer-implemented method of claim 1, further comprising:
polling a queue to obtain a first message corresponding to a first processing task;
configuring the first container to execute the first function based on the first message to perform the first processing task;
polling the queue to obtain a second message corresponding to a second processing task; and
configuring the second container to execute the second function based on the second message to perform the second processing task.

6. The computer-implemented method of claim 1, further comprising launching an agent container within a multi-container computing environment that includes the first function container and the second function container, wherein the agent container causes the first function container to execute the first function and causes the second function container to execute the second function.

7. The computer-implemented method of claim 1, wherein the first function comprises a first media processing operation that generates a first portion of media data, and wherein the second function comprises a second media processing operation that generates a second portion of media data.

8. The computer-implemented method of claim 1, further comprising:
determining that execution of the first function is complete; causing the first function container to release one or more resources associated with the first function;
determining that execution of the second function is complete; and causing the second function container to release one or more resources associated with the second function.

9. The computer-implemented method of claim 1, further comprising:
determining that execution of the first function is complete;
copying the first output data to a shared storage;
determining that execution of the second function is complete; and
copying the second output data to the shared storage,
wherein the first function container and the second function container are coupled to the shared storage.

10. The computer-implemented method of claim 1, wherein the first execution environment and the second execution environment are derived from different operating systems.

11. One or more non-transitory computer-readable media including instructions that, when executed by one or more processors, cause the one or more processors to execute application code across different execution environments by performing the steps of:
causing a first function container to execute a first function based on a first portion of the application code to generate first output data; and
causing a second function container to execute a second function based on a second portion of the application code to generate second output data,
wherein the first function executes within a first execution environment associated with the first container, and wherein the second function executes within a second execution environment associated with the second container.

12. The one or more non-transitory computer-readable media of claim 11, wherein the first execution environment and the second execution environment are derived from different operating systems.

13. The one or more non-transitory computer-readable media of claim 11, further comprising the step of generating a multi-container computing environment that includes the first function container and the second function container, wherein the multi-container computing environment is coupled to a shared storage, and wherein the first function container and the second function container communicate with one another via the shared storage.

14. The one or more non-transitory computer-readable media of claim 11, further comprising the steps of:
executing the first portion of the application code to push a first message onto a queue, wherein the first message corresponds to a first processing task performed during execution of the first function; and
executing the second portion of the application code to push a second message onto the queue, wherein the second message corresponds to a second processing task performed during execution of the second function.

15. The one or more non-transitory computer-readable media of claim 11, further comprising the steps of:
polling a queue to obtain a first message corresponding to a first processing task;
configuring the first container to execute the first function based on the first message to perform the first processing task;
polling the queue to obtain a second message corresponding to a second processing task; and
configuring the second container to execute the second function based on the second message to perform the second processing task.

16. The one or more non-transitory computer-readable media of claim 11, further comprising the step of launching an agent container within a multi-container computing environment that includes the first function container and the second function container, wherein the agent container causes the first function container to execute the first function and causes the second function container to execute the second function.

17. The one or more non-transitory computer-readable media of claim 11, wherein the first function comprises a first media processing operation that generates a first portion of media data, and wherein the second function comprises a second media processing operation that generates a second portion of media data.

18. The one or more non-transitory computer-readable media of claim 11, wherein the first container is configured to execute a first library that is compatible with a first operating system, and the second container is configured to execute a second library that is compatible with a second operating system.

19. The one or more non-transitory computer-readable media of claim 11, further comprising the steps of:
executing the first portion of the application code to trigger a rule-based workflow that populates a queue with a first message corresponding to the first function; and
executing the second portion of the application code to issue an application programming interface (API) call that populates the queue with a second message corresponding to the second function.

20. A system comprising:
one or more memories storing instructions; and
one or more processors coupled to the one or more memories that, when executing the instructions, perform the steps of:
causing a first function container to execute a first function based on a first portion of application code to generate first output data, and
causing a second function container to execute a second function based on a second portion of the application code to generate second output data,
wherein the first function executes within a first execution environment associated with the first container, and wherein the second function executes within a second execution environment associated with the second container.
